(19) United States
(12) Patent Application Publication
(10) Pub. No.: US 2015/0059419 A1
(43) Pub. Date: Mar. 5, 2015

(54) METHOD AND APPARATUS FOR PROCESSING OF FUR

(71) Applicant: Jasopels A/S, Bording (DK)

(72) Inventor: Kurt Pedersen, Vinderup (DK)

(21) Appl. No.: 14/388,184

(22) PCT Filed: Mar. 26, 2013
(86) PCT No.: PCT/EP2013/056357

§ 371 Date: Sep. 25, 2014

(30) Foreign Application Priority Data
Mar. 28, 2012 (DK) PA201200230

(51) Int. Cl. C14B 1/02; C14B 17/14; C14B 15/00

(52) U.S. Cl. CPC C14B 1/02; C14B 15/00; C14B 17/14
USPC 69/22; 69/37

(57) ABSTRACT

A method and an apparatus (1) is disclosed for processing the skin side of a tubular fur (2) arranged on a mandrel (4) so that the skin side of the fur (2) faces outwards, comprising the steps of processing the skin side of the tubular fur (2) by mutually displacing the mandrel (4) and a processing device (5, 5a, 5b, 6, 6a, 6b, 7, 8, 8a, 9, 9a) in a longitudinal direction of the mandrel (4) while said processing device engages the skin side of the tubular fur (2), determining a transition between a lower end part (2a) of the tubular fur (2) and a surface (4c) of the mandrel (4) by means of mutually displacing the mandrel (4) and a colour sensor (10) directed towards the mandrel (4) in a longitudinal direction of the mandrel (4), and terminating the processing step in dependence of said determined transition.

The present invention relates to an apparatus for processing the skin side of a tubular fur.

### BACKGROUND

A skin taken from a furred animal such as a mink normally has a layer or residues of fat, tendons and/or flesh that is firmly attached to the skin side of the tubular fur. Before the fur can be used for further processing, such layers or residues must be removed from the skin side.

A prior art apparatus for processing such furs to remove layers or residues of fat, tendons and/or flesh on the skin side is described in Danish patent specification DK156669. This apparatus comprises a single scraper roller with V-shaped scraping elements to scrape the skin on each side of a mandrel, on which a tubular fur is arranged with the skin side facing outwards.

Danish patent specification DK173611 describes an apparatus for processing fur on a mandrel. The apparatus comprises several scraper rollers that, while scraping the skin side of the fur, cause the fur to rotate about its longitudinal axis.

International patent application WO 2012/019607 A1 discloses an apparatus for processing of fur and comprising two sets of scraper rollers arranged to process opposing sides of a tubular fur on a mandrel, where the sides comprises the skin parts that have covered the animal's legs. Both rollers of each set rotate in the same direction.

European patent specification EP2093299 concerns an apparatus for processing fur in which the apparatus comprises two scraper rollers driven in opposite directions of rotation to achieve both a friction force against a thick end of a mandrel on which a fur is arranged and a friction force against the thin end of the mandrel. The mandrel with the skin arranged thereon is driven in its longitudinal direction between the scraper rollers to the lower end of the fur has passed the last scraper rollers. An optical sensor is arranged to measure the extent of the fur on the mandrel by means of a strip of a material recognizable by the optical sensor arranged on the surface of the mandrel. The optical sensor is prior to the scraping moved along the mandrel from a thinner, free end thereof towards the mandrel's thicker end and detects when the strip is recognised, and the position is given to the control unit of the processing apparatus, so that the subsequent scraping can be terminated at the end of the fur.

The length of the tubular furs has significant variations as to age and sex of the animals. The prior art solution to the processing of tubular furs or different lengths was to continue the processing along the mandrel to a position where even the longest furs would be processed. However, this requires an equally long processing time for each tubular fur, regardless of its length, and a substantially increase in the throughput of furs of a processing apparatus can be obtained by adjusting the processing length and thereby the processing time to the actual length of the individual tubular fur.

It is an object of the present invention to provide a method and an apparatus for processing of the skin side of a tubular fur, where an improved manner of determining the optimal position to end the processing based on the extent of the tubular fur is provided.

### BRIEF DESCRIPTION OF THE PRESENT INVENTION

The object is achieved by the present invention by using a colour sensor to detect the transition on the mandrel between the skin side of the fur and the surface of the mandrel. The colour sensor may detect the colour of the mandrel surface itself and is thus not dependent on a particular strip on the surface of the mandrel, which is most likely to become damaged during use of the apparatus and thus requires to be replaced regularly to ensure that the system is functioning. With a colour detector, the only requirement for the system to be reliable is a detectable difference between the colour of the surface material of the mandrel and the skin side of the fur.

Thus, the present invention relates to a method for processing the skin side of a tubular fur comprising the steps of drawing the tubular fur on a mandrel from a free end of the mandrel so that the skin side of the fur faces outwards and the fur side of the fur faces inwards towards the mandrel, processing the skin side of the tubular fur by mutually displacing the mandrel and a processing device in a longitudinal direction of the mandrel while said processing device engages the skin side of the tubular fur, determining a transition between a lower end part of the tubular fur and a surface of the mandrel by means of mutually displacing the mandrel and a colour sensor directed towards the mandrel in a longitudinal direction of the mandrel, and terminating the processing step in dependence of said determined transition.

The mandrel may preferably be a tapering mandrel which fits the shape of the tubular skin, the mandrel may be made with a square cross-section or with a round or rounded cross-section. In a preferred embodiment, the mandrel is moved while the processing device is stationary, but the opposite is also a possibility within the present invention. In other embodiments, the mandrel may be rotated during the processing of the skin side of the fur while it is moved past a processing device or while a processing device is moved past the rotating mandrel.

For most known skin side processing processes, the start of processing of the skin side of the tubular fur is made from the free end of mandrel and at termination of the processing, the parts, i.e. the mandrel and/or the processing device returns to the start position where the processing device to positioned near the free end of the mandrel.

The processing device may preferably comprise one or more processing tools, in particular scraping rollers having scraping elements for scraping the skin side of the fur, and may additionally or alternatively include e.g. brushes for brushing the skin side of the tubular fur.

With a reliable method for detecting the transition from the skin side of the fur and the surface material of the mandrel, it can be ensured that the processing of the skin side of the tubular fur is terminated at the correct position and the processing time may for that reason be shortened and the throughput of the apparatus may therefore me improved.

In a preferred embodiment, the colour sensor is arranged substantially stationary with respect to the processing device so that the mutual movement of the processing device and the mandrel is simultaneous with the mutual movement of the colour sensor and the mandrel.

The colour sensor may be arranged to give an output when the transition takes place, i.e. when the colour changes from skin side colour to the colour of the mandrel surface material and the control of the operation of the processing device will act accordingly. Alternatively, the colour sensor is arranged to provide a continuous output or a periodic output representing the colour of a detection area as determined by the colour sensor and a control device of the apparatus determines the transition from those output data.

In a particular embodiment, the colour sensor is arranged to move relatively past the mandrel prior to the processing of the tubular fur in order to determine the position of the lower end part of the tubular fur, which subsequently is used for controlling the termination of the processing step in dependence of said position. In this embodiment, the colour sensor is not arranged to be stationary with respect to the processing device.

The transition is in a particular embodiment determined by the detection of the colour of the mandrel surface by the colour sensor. As the colour of the skin side of the tubular fur may vary between different furs and within the individual fur, the colour of the mandrel surface is a much more constant feature to measure. The colour of the surface material of the mandrel will not change due to wear of the mandrel and is therefore a highly reliable feature to base a detection system on. The colour of the mandrel surface towards which the colour sensor is directed is in preferred embodiments in the range of 400 to 540 nm, preferably in the range of 460 to 520 nm, such as the colour cyan which deviates sufficiently from the yellow/red colours of the skin side of the tubular furs.

Alternatively, the transition may be determined by the detection of the colour of the skin side of the tubular fur by the colour sensor, in particular in case the tubular fur is scanning by the colour sensor starting from the thick end of the mandrel and moving towards the free end of the mandrel.

The present invention also relates to an apparatus for processing the skin side of a tubular fur, which apparatus comprises a mandrel on which the tubular fur can be drawn from a free end of the mandrel, so that the skin side of the fur faces outwards and the fur side of the fur faces inwards towards the mandrel, a processing device for processing the skin side of the tubular fur, a colour sensor directed towards the mandrel, driving arrangement for mutually displacing the mandrel and the processing device in a longitudinal direction of the mandrel, and for mutually displacing the mandrel and the colour sensor in a longitudinal direction of the mandrel, and a control device arranged for terminating processing of the skin side of the fur by the at least one processing device in response to an output from the colour sensor indicating a transition between a lower end part of the tubular fur and a surface of the mandrel during the mutual displacement of the mandrel and the colour sensor.

The processing device may in particular comprise at least one scraper roller which, during operation and in contact with the skin side, is arranged to rotate so that scraping elements on the scraper roller scrape the skin side of the fur.

The driving arrangement is in a preferred embodiment arranged to drive the mandrel in its longitudinal direction whereas the processing device remains stationary during operation of the apparatus.

The apparatus according to the present invention may comprise the technical features described with respect to the method of the present invention.

### BRIEF DESCRIPTION OF THE FIGURES

The following contains non-limiting examples of embodiments of the invention described and explained in detail with reference to the figures, where:

FIG. 1 is a sketch of a side view of an apparatus according to the present invention, and

FIG. 2 shows a part of the embodiment of FIG. 1 an apparatus in accordance with the invention, seen in perspective, with both horizontal and vertical scraper rollers.

### DETAILED DESCRIPTION

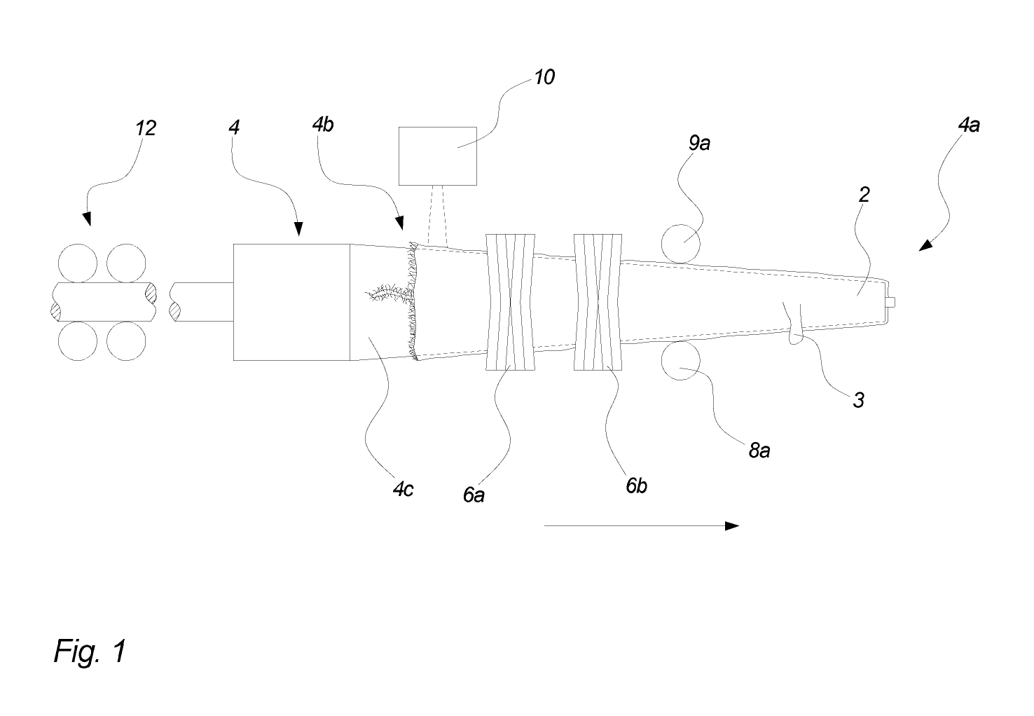

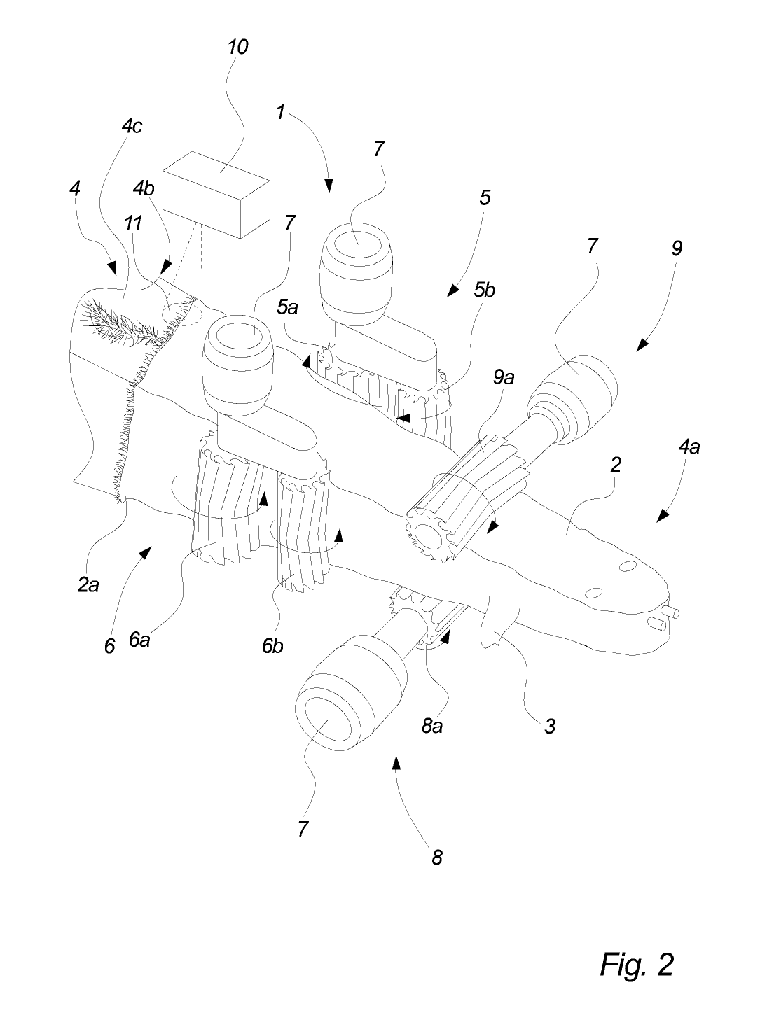

FIGS. 1 and 2 show an advantageous embodiment of an apparatus 1 in accordance with the invention for processing the skin side of a tubular fur 2, preferably a mink fur.

The tubular fur 2 comprises a fur side and a skin side. The fur comprises different skin parts that originally, before the fur was removed from the furred animal, enclosed different parts of the body of the furred animal, such as skin parts 3 that enclosed the legs of the furred animal.

The fur is placed on a mandrel 4 with a first part 4a that is thinner than a second part 4b of the mandrel 4. The mandrel 4 is thus formed with a tapered end, where the fur 2 can be drawn on the mandrel 4 from a free end of the mandrel 4 where the thin part 4a is. The surface 4c of the mandrel 4 is made from a plastic material of a cyan colour, i.e. reflecting light of a wavelength in the range of 500 to 520 nm

The apparatus 1 also comprises two vertical scraper arrangements 5, 6, each comprising two scraping means in the form of scraper rollers 5a, 5b, 6a, 7b designed to rotate to apply a force to the skin side of the fur 2 from opposite sides of the mandrel 4 in a direction towards the second part 4b of the mandrel 4, i.e. the thicker part of the mandrel 4. The first vertical scraper unit 5 thus comprises a first scraper roller 5a and a second scraper roller 5b, and the second vertical scraper unit 6 comprises a first scraper roller 6a and a second scraper roller 6b.

The scraper rollers in a scraper unit 5, 6 are, as indicated with arrows, arranged to rotate in the same direction of rotation. This means that the scraper rollers 5a, 5b in the first scraper unit 5 are arranged to rotate in the same direction of rotation and the scraper rollers 6a, 6b in the second scraper unit 6 are arranged to rotate in the same direction of rotation. However, the present invention may as well be applied with other scraping arrangements where the second scraper rollers 5b, 6b are omitted, are rotating in a direction opposite to the first scraper rollers 5a, 6a or are replaced with brushes etc.

The scraper units 8, 9 with the horizontally arranged scraper rollers 8a, 9a are arranged to scrape the remaining horizontal planes of the skin side of the fur 2 and will thereby apply a force to the skin side from opposite sides of the mandrel 4, i.e. in this case the top and bottom surfaces of the mandrel 4, in a direction towards the second part 4b of the mandrel 4.

The mandrel 4 and the scraper units 5, 6, 8, 9 are arranged to be moved in relation to each other in the longitudinal direction of the mandrel 4 as indicated by the straight arrow in FIG. 1. This is achieved by the mandrel 4 being moved towards the tapered end 4a of the mandrel 4 during processing of the skin side of the fur 2, while the scraper units 5, 6, 8, 9 are stationary with respect to the longitudinal direction of the mandrel 4. The longitudinal movement of the mandrel 4 is driven by a mandrel drive arrangement 12 indicated in FIG. 1.

Alternatively, the mandrel 4 could be fixed and the scraper units 5, 6, 8, 9 could thus be moved along the mandrel 4. Equally, both the mandrel 4 and the scraper units 5, 6, 8, 9 could be moved in relation to each other.

The scraper units 5, 6, 8, 9 are arranged to be movable towards and away from the mandrel 4 in order to be able to apply a controlled contract pressure against the skin side of the fur 2 on the mandrel 4. This may, for example, be controlled via one or more pressure arrangements, comprising, for example, linear actuators such as pneumatic cylinders, a spindle or other suitable device.

The scraper rollers 5a, 5b, 6a, 6b, 8a, 9a are driven by motors 7 as shown in FIG. 2, which may be electric or pneumatic motors.

The colour sensor 10 is arranged on the same structural part (not shown) of the apparatus 1 as the scraper units 5, 6, 8, 9 and are thus stationary with respect to those, at least in the longitudinal direction of the mandrel 4. The colour sensor 10 is directed to a side surface of the mandrel 4 so that the detection area 11 of the colour sensor 10 is on the surface of the skin side of the fur 2 or on the top surface of the mandrel 4, depending on the length of the fur 2 and the longitudinal position of the mandrel 4. The colour sensor 10 emits a white light towards the detection area and measures the chromatic distribution of red, blue and green in the reflected radiation. The measurements are compared to stored reference values and a set of tolerance range values, and an output is provided to the control device (not shown) of the apparatus 1. This output may signify recognition of the skin side of the fur 2, of the surface colour of the mandrel 4 or of the transition between the two. In order to separate the skin side of the fur 2 from the surface of the mandrel 4, it is advantageous that the mandrel surface is made from a material of a colour that deviates significantly from the colour of the skin side of the fur 2, which preferably is a cyan colour where the reflected light primarily is within a wavelength range of 500 to 520 nm, but the colour may also be of a shorter wavelength, i.e. more towards blue.

The colour sensor 10 is in the embodiment shown in the figures arranged prior to the processing device so that the detection area 11 of the colour sensor 10 is ahead of the scraper rollers 5a, 5b, 6a, 6b of the first and second vertical scraper arrangements 5, 6 which are the first ones to process the skin side of a fur 2. This arrangement allows these scraper rollers 5a, 5b, 6a, 6b to be retracted from the contact with the fur at the lower end part 2a of the turbulent fur 2 and thus to substantially avoid contact between the scraper rollers 5a, 5b, 6a, 6b and the surface 4c of the mandrel 4. In an alternative embodiment, the colour sensor 10 is arranged between the vertical scraper arrangements 5, 6 and the horizontal scraper arrangements 8, 9 or alternatively above or right after the horizontal scraper arrangements 8, 9 so that the processing of the skin side of the fur 2 is terminated when the colour sensor 10 detects the transition between the lower end part 2a of the tubular fur 2 and the surface 4c of the mandrel 4.

The processing of the tubular fur 2 is started by arranging the fur 2 on the mandrel 4 from the free end thereof when the mandrel 4 is displaced to the left as seen in FIG. 1 which is the retracted starting position of the mandrel 4. The fur 2 is arranged with the skin side outwards and the fur side inwards toward the surface 4c of the mandrel 4. The mandrel 4 is driven in its longitudinal direction by means of the drive arrangement 12 towards the scraper arrangements 5, 6, 8, 9 which are engaging the skin side of the fur 2 for the removal of tissue, fat and tendons. When the mandrel 4 has reached a position where the detection area 11 of the colour sensor 10 detects the colour of the surface 4c of the mandrel 4, the sensor 10 emits an output to the control device (not shown) which indicates the transition between the skin side of the fur 2 and the mandrel surface 4c and thereby the position of the lower end part 2a of the tubular fur 2. The control device will terminate the scraping process a short time period after it has received the output from the colour sensor 10, the length of the time period depending on the speed of which the mandrel 4 is driven in its longitudinal direction, so that the full length of the fur 2 is scraped.

The colour sensor 10 may further be employed for emergency stop of the apparatus. In case the tubular fur 2 is torn during the processing, the colour sensor 10 will detect the transition from skin side of the fur 2 to the surface material of the mandrel 4 at an unexpected time in the processing operation, and the apparatus will be stopped immediately an thus prevent further damage to the fur, which may be partly saved, as well as to the apparatus, where pieces of the torn fur 2 may injure moving parts.

### LIST OF REFERENCES

1: Apparatus for processing the skin side of a tubular fur
2: Tubular fur
2a: Lower end part of tubular fur
3: Skin parts that have covered a furred animal's legs
4: Mandrel with tapered end
4a: First part of the mandrel that is thinner than a second part of the mandrel
4b: Second part of the mandrel
4c: Surface of mandrel
5, 6: Vertical scraper arrangements
5a, 5b: Scraper rollers in a first vertical scraper arrangement
6a, 6b: Scraper rollers in a second vertical scraper arrangement
7: Drive unit to drive scraper rollers
8, 9: Horizontal scraper arrangements
8a, 9a: Scraper rollers arranged horizontally
10: Colour sensor
11: Detection area of colour sensor
12: Drive means for driving the mandrel in a longitudinal direction

1. Method for processing the skin side of a tubular fur comprising the steps of
drawing the tubular fur on a mandrel from a free end of the mandrel so that the skin side of the fur faces outwards and the fur side of the fur faces inwards towards the mandrel,
processing the skin side of the tubular fur by mutually displacing the mandrel and a processing device in a longitudinal direction of the mandrel while said processing device engages the skin side of the tubular fur,
determining a transition between a lower end part of the tubular fur and a surface of the mandrel by means of mutually displacing the mandrel and a colour sensor directed towards the mandrel in a longitudinal direction of the mandrel, and
terminating the processing step in dependence of said determined transition.

2. Method according to claim 1, wherein the colour sensor is arranged substantially stationary with respect to the processing device.

3. Method according to claim 1, wherein the transition is determined by the detection of the colour of the mandrel surface by the colour sensor.

4. Method according to claim 3, wherein the colour of the mandrel surface towards which the colour sensor is directed is in the range of 400 to 540 nm.

5. Method according to claim 1, wherein the transition is determined by the detection of the colour of the skin side of the tubular fur by the colour sensor.

6. Method according to claim 1, wherein the mandrel is displaced in its longitudinal direction during the processing step.

7. Method according to claim 1, wherein the colour sensor provides an output to a control device, and the control device terminates the processing step in dependence of the output from the colour sensor.

8. An apparatus for processing the skin side of a tubular fur, which apparatus comprises
a mandrel on which the tubular fur can be drawn from a free end of the mandrel, so that the skin side of the fur faces outwards and the fur side of the fur faces inwards towards the mandrel,
a processing device for processing the skin side of the tubular fur,
a colour sensor directed towards the mandrel,
driving arrangement for mutually displacing the mandrel and the processing device in a longitudinal direction of the mandrel, and for mutually displacing the mandrel and the colour sensor in a longitudinal direction of the mandrel, and
a control device arranged for terminating processing of the skin side of the fur by the at least one processing device in response to an output from the colour sensor indicating a transition between a lower end part of the tubular fur and a surface of the mandrel during the mutual displacement of the mandrel and the colour sensor.

9. An apparatus according to claim 8, wherein the colour sensor is arranged substantially stationary with respect to the processing device.

10. An apparatus according to claim 8, wherein the output from the colour sensor in response to which the processing of the skin side is terminated indicates the detection of the colour of the mandrel surface by the colour sensor.

11. An apparatus according to claim 10, wherein the colour of the mandrel surface towards which the colour sensor is directed is in the range of 400 to 540 nm.

12. An apparatus according to claim 8, wherein the output from the colour sensor in response to which the processing of the skin side is terminated indicates the detection of the skin side of the tubular fur by the colour sensor.

13. An apparatus according to claim 8, wherein the processing device comprises at least one scraper roller which, during operation and in contact with the skin side, is arranged to rotate so that scraping elements on the scraper roller scrape the skin side of the fur.

14. An apparatus according to claim 8, wherein the driving arrangement is arranged to drive the mandrel in its longitudinal direction whereas the processing device remains stationary during operation of the apparatus.

15. Method according to claim 3, wherein the colour of the mandrel surface towards which the colour sensor is directed is in the range of 460 to 520 nm.

16. An apparatus according to claim 10, wherein the colour of the mandrel surface towards which the colour sensor is directed is in the range of 460 to 520 nm.
